(19) United States
(12) Patent Application Publication
(10) Pub. No.: US 2011/0309704 A1
(43) Pub. Date: Dec. 22, 2011

(54) Energy source machine of permanent magnets and elevated weights rotating

(76) Inventor: Ezra Shimshi, Atlanta, GA (US)

(21) Appl. No.: 13/199,331

(22) Filed: Aug. 26, 2011

Related U.S. Application Data
(63) Continuation-in-part of application No. 12/378,849, filed on Feb. 20, 2009.

(51) Int. Cl. H02K 21/00; H02N 11/00

(52) U.S. Cl. 310/152; 74/DIG. 9

(57) ABSTRACT

The present invention is an energy source machine comprising in one version of the embodiment of the present invention a vertically rotating base on a spindle held by a frame. The base comprises sliding cross rods, switchable permanent magnets and weight-units. When a rod becomes vertical it slides by the magnetic force of the respective magnet. As the rod slides it elevates its respective weight-units, one above the spindle and one under the spindle. Since the weight-unit above the spindle moves away from the spindle and the weight-unit under the spindle moves toward the spindle, a potential energy is created above the spindle. As the weight-unit above the spindle falls the potential energy is converted to kinetic energy and as the weight-units continue to rotate the kinetic energy becomes rotary energy that can be converted to electricity.

Continuation-in-part of prior application Ser. No. 12/378,849 Filing Date: Feb. 20, 2009; Art Unit: 2839 Examiner: Zarroli, Michael C

### BACKGROUND OF THE INVENTION

a) Field of the Invention

The present invention relates to machines that can supply independent and reliable energy from magnetic forces of permanent magnets. The magnetism of the permanent magnets are configured to be switched to “ON” and to “OFF” mechanically by triggers within the machines.

b) The Prior Art

There are no machines to this day that can supply independent and reliable energy from permanent magnets. Each mechanically switchable permanent magnet comprises a permanent magnet in a housing with a switch that can be switched to “ON” and to “OFF” by turning the switch back and forth. Such magnets are available in the open market in various sizes and strengths.

### SUMMARY OF THE INVENTION

The present invention introduces switchable permanent magnets as a source of energy. One version of the embodiments of this invention comprises rotating base, two magnets, a rod, two weight-units connected to the base and to the rod and two triggers. When the magnets and the rod are positioned between the triggers the magnetic force of the bottom magnet pulls the rod and the weight-units are elevated, one above the spindle and one under the spindle, creating potential energy above the spindle that forces the base to rotate as the weight-unit above the spindle falls.

### BRIEF DESCRIPTION OF THE DRAWINGS

The present invention will be more readily understood by reference to the following description, taken with the accompanying drawings, in which:

FIG. 1 is a front view of a flat rectangular base on a spindle held by a frame and showing one rod, two weight-units, two targets, two permanent magnets with a switch in each magnet, and two triggers.

FIG. 2 is identical to FIG. 1, but the base is round and has a second set of components as seen in FIG. 1.

FIG. 3 is a front view showing the inner switchable magnets after having been forced upward with their weight-units when the two top magnets are switched to “ON” and the two bottom magnets are switched to “OFF”.

FIG. 4 is identical to FIG. 3, but it shows the inner and the outer magnets after making 180 degrees rollover and just before the inner magnets are about to jump upward.

FIG. 5 shows a set of two switchable magnets revolving with a spindle. The spindle is the target of the magnets and the magnets are seen just before being elevated when the top magnet is switched to “OFF” and the Bottom magnet is switched to “ON”.

FIG. 6 is identical to FIG. 5, but with two sets of switchable magnets revolving with the spindle and are positioned in 90 degrees angle to each other and with one set seen after having been elevated.

FIG. 7 shows two units of magnets connected through their spindles. Each unit comprises of one switchable magnet with N/S switch, which is also the axis of rotation. Two permanent magnets are seen in each unit, which are configured to revolve with the switchable magnet and to jump upward as soon as the respective switchable magnets are switched by the triggers from “N” to “S” and from “S” to “N”.

### DESCRIPTION OF THE EMBODIMENT

Parts in the embodiment and its designated numbers in the drawings are:
Base—3;
Weight-unit—4;
Rod—5;
Magnet—6;
Switch—7;
Trigger—8;
Target/Guider—9;
Spindle—10;
Frame—11;
Permanent-magnet—12;
Vertical-line—20.

The invention may be implemented in a wide range of embodiments, each configured to carry a load such as running a generator with an output that should maintain an effective speed rate of rotation

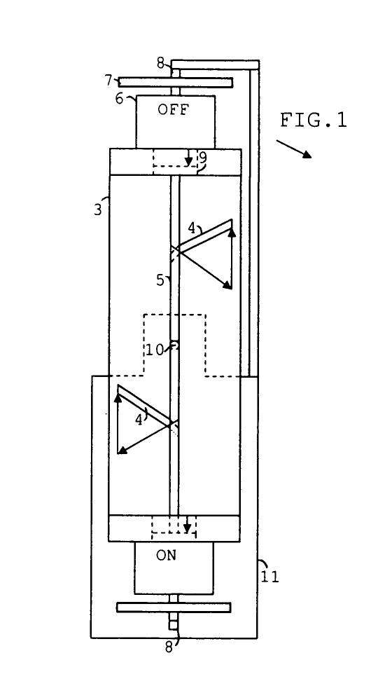

Referring to FIG. 1, thereof, a rectangular base 3 is configured to rotate vertically on a spindle 10. Spindle 10 is held by frame 11. Rod 5 is held by a base 3 and is configured to slide along the base 3 between two thin walls fixed to base 3. Rod 5 has a target 9 fixed to each of its ends and two weight-units 4, each weight-unit 4 is connected to the base 3 and to the rod 5, one weight-unit 4 is seen above spindle 10 and one weight-unit 4 under spindle 10. Each target 9 is facing a magnet 6 confined in a housing fixed to base 3 and having a switch 7. A top trigger 8 and a bottom trigger 8 are fixed to frame 11 and the triggers 8 are configured to switch each switch 7. When the two magnets 6 are positioned between the triggers 8, the top magnet 6 is switched to “OFF”, the bottom Magnet 6 is switched to “ON” and the Rod 5 slides downwards forcing the weight-units 4 upward. Each weight-unit 4 goes through one of the thin wall and is connected to rod 5. As rod 5 is forced downward by its weight and a magnetic pull, the short section of each weight-unit 4 between the thin walls is forced down, which forces the long section of the weight-unit 4 up. This is analogous to two kids sitting on the short wing of a seesaw and forcing the long wing of the seesaw upward. In a similar version, the spindle 10 can be a shaft of a generator. The magnets 6 can be fixed to frame 11, one magnet 6 at the top and one magnet 6 at the bottom. The triggers 8 can be fixed to base 3 and rotate with base 3.

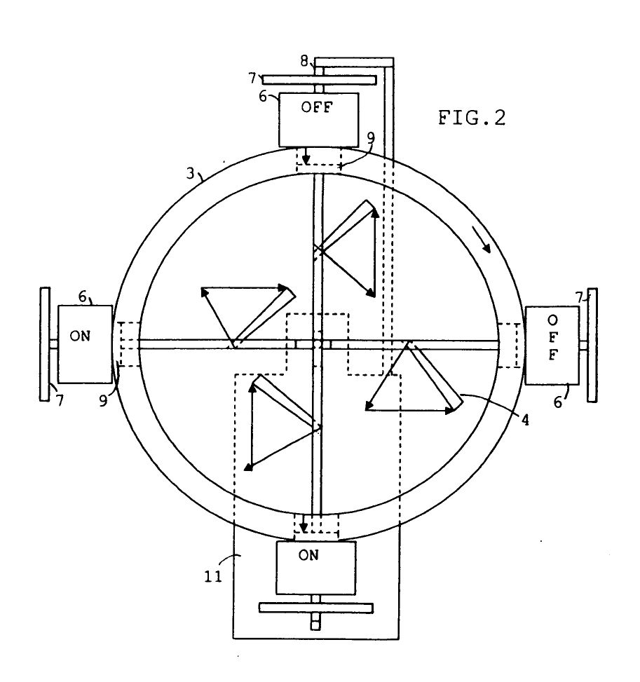

FIG. 2 is similar to FIG. 1. The round base 3 includes additional rod 5 at ninety degrees angle to the rod 5 seen in FIG. 1. Each magnet 6 is inside housing with switch 7 that can be turned by the respective trigger 8 to “ON” or to “OFF”. When one rod 5 crosses the vertical-line zone, switch 7 of the bottom magnet 6 is switched by the bottom trigger 8 to “On” and switch 7 of the top magnet 6 is switched by the top trigger 8 to “Off”. Then, the top target 9 disengages from the top magnet 6 and the bottom target 9 engages the bottom magnet 6, forcing the vertical rod 5 to slide downwards by the magnetic pull of the bottom magnet 6, forcing the weight-units 4 of the vertical rod 5, upward and, in turn, the elevated weight-units 4 force the base 3 to rotate in the direction of weight-unit 6, which is above spindle 10. This is because the weight-unit 6 above spindle 10 has moved away from spindle 10. The weight-unit 6 under spindle 10, on the other hand, has moved toward spindle 10. These movements by the weight-units 4 forced the base 3 to rotate in one direction. The magnetic force of the bottom magnet would have been converted to rotary energy, which can be converted to electricity. This embodiment of the present invention can include multiple sets of the same components on one rotating base 3, or multiple units of bases on a single spindle. The switching of the magnets to “ON” and to “OFF” can be made by various means such as a mass unit fixed to an extended arm fixed to the switch of each magnet.

FIG. 3 shows four switchable magnets 6 configured to rotate with the horizontal spindle 10 held by frame 11. The two outer magnets 6 are fixed to spindle 10 by guider 9. The two inner magnets 6 are connected by guider 9 that made to slide through spindle 10. When the magnets 6 cross the vertical-line 20, the top triggers 8 turn the top switches 7 to “ON” position and the bottom triggers 8 turn the bottom switches 7 to “OFF” position. The combined pulling forces of the top magnets 6 elevate the inner magnets 6 and any respective weight-units, such as the weight of the guider 9 and weight-units “W”, which create an imbalance between the moving parts above the spindle 10 and the moving parts under the spindle 10. This repeated imbalance causes a rotation in one direction.

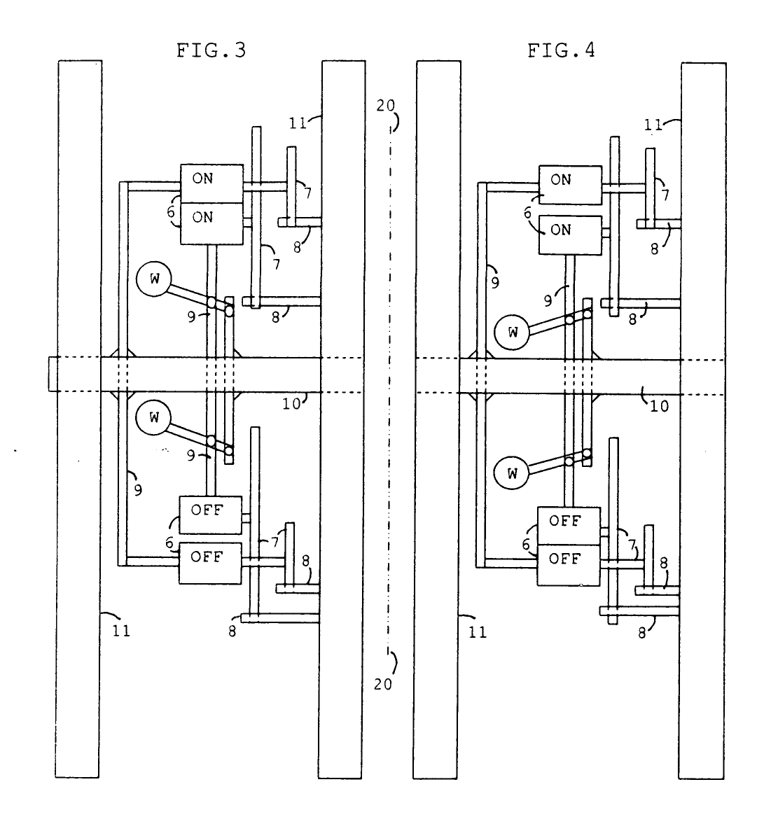

FIG. 4 is identical to FIG. 3 and it shows the inner magnets 6 before their elevation but after their 180 degrees rollover from the position of the magnets 6 seen in FIG. 3.

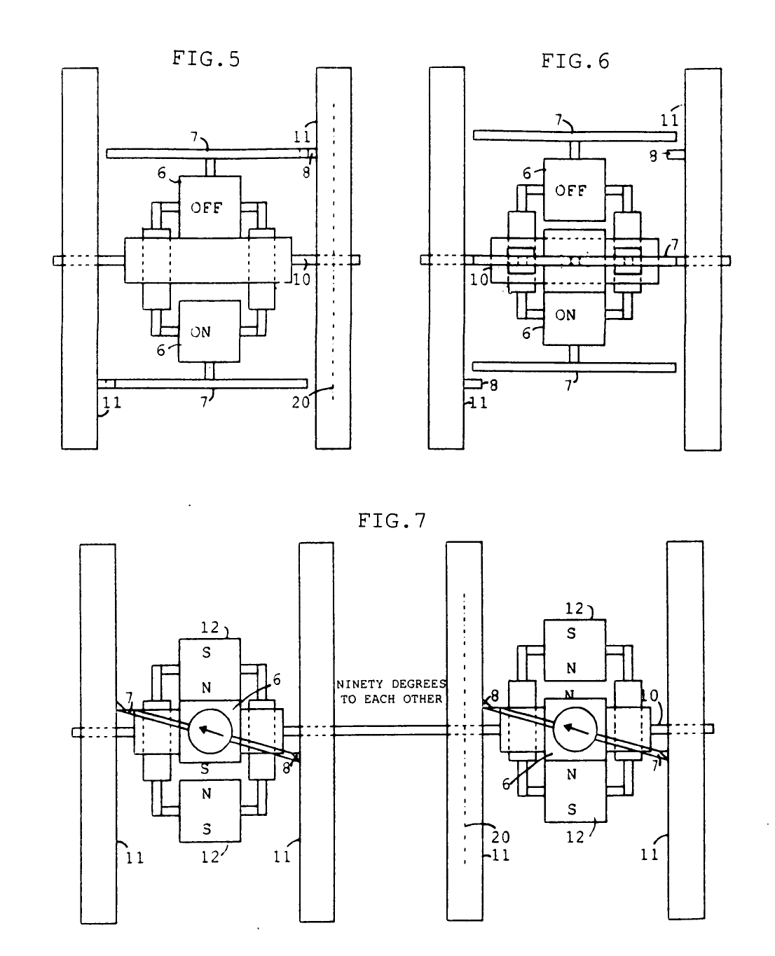

FIG. 5 shows a large diameter spindle 10 held by frame 11. A pair of switchable magnets 6 are seen, one above the spindle 10 and one under spindle 10. Each magnet 6 has a switch 7 that can be turned by two triggers 8 to “ON” or to “OFF”. The bottom magnet 6 is “ON” and the upper magnet is “OFF” when the magnets are at the vertical-line 20 zone. The magnets 6 are seen just before they are about to be lifted by the magnetic force of the bottom magnet 6 toward the spindle 10.

FIG. 6 is identical to FIG. 5, but with an additional pair of switchable magnets 6. The additional magnets 6 however are positioned horizontally at 90 degrees angle to the vertically positioned magnet 6. The vertically positioned magnets 6 have moved up as did the horizontally magnets 6 when they were at the vertical-line 20 zone.

FIG. 7 shows two identical units of magnets on a single spindle 10 held by frame 11. Each unit comprises of one switchable magnet 6 and two permanent magnets 12. The two units are positioned at 90 degrees angle to each other, which is not reflected in the drawing, for mere simplicity. The emphasis should be in showing the combination of magnetic pull and push forces that can lift each pair of the permanent magnets 12 when at the zone of vertical-line 20. Each switchable magnet 6 is riding the spindle 10 in its unit and serving also as an axis of rotation with N/S switch 7 to be switched by the two triggers 8. Every 180 degrees rollover by the lined-up of the three magnets in each unit, the respective switchable magnet 6 changes its poles from “NORTH” to “SOUTH”, or from “SOUTH” to “NORTH”, so that the bottom permanent magnet 12 is always facing an opposite magnetic pole by the switchable magnet 6 and the upper permanent magnet 12 is always facing the same magnetic pole by the switchable magnet 6. This repeated rearrangements create two magnetic forces, pull and push, that drive the permanent magnets upward and, thus, create a force that turns the magnets in unidirectional rotation.

While this invention has been described with reference to the mechanism disclosed herein, it is not confined to the details as set forth and is not intended in any way to limit the broad features or principles of the present invention, or the scope of patent monopoly to be granted. This application is intended to cover any modification or changes that may come within the scope of the following claims.

I claim as my invention:

1. Energy source machine of vertically rotating base on a spindle held by a frame, comprising a rod with one target at each end of the rod facing a switchable permanent magnet, weight-units, each connected to the rod and to the base, one at each side of the spindle, and two triggers, one top trigger and one bottom trigger fixed to the frame, wherein as the rod lines-up with the vertical-line the rod is forced to slide along the base by the magnetic force of the respective magnet, wherein the weight-units are forced upward by the rod and propelling the base to rotate in the direction of the elevated weight-unit situated above the spindle and has moved away from the spindle.

2. The energy source machine according to claim 1, wherein each magnet is a permanent magnet enclosed in a housing fixed to the base and having a switch configured to switch the magnet to “ON” and to “OFF” by the respective triggers.

3. The energy source machine according to claim 1, wherein each weight-unit is connected to the rod and to the base, wherein when one weight-unit is above the spindle and one weight-unit is below the spindle the weight-units are configured to be elevated by the rod as the rod crosses the vertical line, wherein the rod at the vertical-line zone slides and is traveling a short straight-line distance, wherein the weight-units are elevated by the sliding rod and are traveling a long curved-line distance.

4. The energy source machine according to claim 3, wherein the rod at the vertical-line zone slides downwards by the force of the magnetic pull of the magnet at the bottom of the base as soon as the trigger at the top turns the switch of the magnet at the top of the base to “OFF” and the trigger at the bottom turns the switch of the magnet at the bottom of the base to “ON”.

5. The energy source machine according to claim 1, wherein the rod is configured to slide vertically along the base between two thin walls fixed to the base.

6. The energy source machine according to claim 4, wherein the triggers can be configured to turn the switches of the magnets with a minimum force also through switches with long arms and through mass-unit attached to each switch and responding to gravity pull.

7. The energy source machine according to claim 1, wherein the trigger at the top turns the switch of the magnet when at the top of the base to “OFF” position, wherein the target at the top disengages the magnet at the top of the base, wherein the trigger at the bottom turns the switch of the magnet when at the bottom of the base to “ON” position, wherein the target at the bottom engages the magnet at the bottom of the base, wherein the rod is forced to slide downwards by the magnetic pull of the magnet at the bottom of the base.

8. The energy source machine according to claim 7, wherein the vertically positioned rod is forced downwards by the magnetic force of the bottom magnet and, in-turn, the rod forces the weight-units upward, wherein the elevated weight-units create a force that rotates the base in the direction of the weight-unit above the spindle, which have moved away from the spindle.

9. The energy source machine according to claim 5, wherein each weight-unit is connected to the rod through the respective thin wall so that when the rod slides downwards the rod forces the short section of the weight-unit within the thin walls down, which lifts the long section of the weight-unit outside the thin walls.

10. A method for converting magnetic force to electricity, including the step of rotating a plane base on a shaft of a generator, wherein the base comprises two cross rods with a target fixed to each end of each rod and each target faces a magnet within a housing having a switch, wherein each housing is fixed to the base, wherein each rod is configured to slide along the base between two thin walls fixed to the base, and including the step of elevating weight-units, wherein two weight-units are attached to each rod opposite to each other and separated by the shaft and are configured to be elevated by the rod that crosses the vertical-line zone and is forced to slide by the magnetic pull of the respective magnet at the moment the switches of the respective magnets are turned from “OFF” to “ON” and from “ON” to “OFF” so as to force the vertical rod to slide that elevates the respective weight-units, which rotate the base in one direction.

11. The method for converting magnetic force according to claim 10, wherein the sliding vertical rod covers a short straight-line distance and each elevated weight-unit covers a long curved-line distance, wherein the elevated weight-units create an imbalance that forces the base to rotate.

12. The method for converting magnetic force according to claim 11, wherein the elevated weight-units propel the base in the direction of the elevated weight-unit above the shaft and has moved away from the shaft.

13. The method for converting magnetic force according to claim 10, wherein each weight-unit is connected to the base and to the respective rod, wherein the short section of the respective weight-unit within the thin walls is forced to move a short distance by the respective sliding rod and the long section of said weight-unit is forced to move a long distance upward.

14. The method for converting magnetic force according to claim 10, wherein a number of bases can be rotating on a single shaft, each base comprising cross rods and weight-units, including the step of forcing the rods that reach vertical position to slide, and including the step of elevating the weight-units, wherein the potential energy of the elevated weight-units in each base is converted to rotary energy that can be converted to electricity.

15. The method for converting magnetic force according to claim 14, wherein all the elevated weight units are forced upward by the weight of the vertically positioned rods and the magnetic pulls of the respective magnets.

16. Energy machine, comprising a spindle held by a frame, permanent magnets with units of mass are configured to revolve with the spindle on a vertical plan, triggers configured to switch the magnetism of the respective magnets through switches in order to create magnetic forces that can elevate the respective magnets and the unit of mass so as to force the magnets and the units of mass to rotate in one direction.

17. The energy machine according to claim 16, wherein one pair of switchable permanent magnets are above the spindle and one pair of switchable permanent magnet are under the spindle, wherein two inner magnets and two outer magnets are configured to be switched to “ON” and to “OFF” by the respective triggers, wherein as soon as the pair of magnets above the spindle are switched to “ON” and the pair of magnets under the spindle are switched to “OFF” magnetic forces elevate the inner magnets with the units of mass, wherein the elevated magnets and the units of mass create potential energy above the spindle which is converted into rotary energy as the magnets and the units of mass above the spindle fall and continue to rotate in one direction.

18. The energy machine according to claim 16, wherein the magnets are a pair of switchable permanent magnets that can be switched to “ON” and to “OFF” by the respective triggers, wherein one magnet is above the spindle and one magnet is under the spindle and are connected by guiders, wherein the spindle is of large diameter and is made of material attractive to magnetism, wherein when the magnet above the spindle is switched to “OFF” and the magnet under the spindle is switched to “ON” the magnet under the spindle is pulled upward to the spindle and both magnets are elevated creating potential energy above the spindle that is converted to kinetic energy as the magnet above the spindle falls and the pair of magnets continues to rotate, wherein another identical pair of magnets rotating on the same spindle 90 degrees angle from the first pair of magnets is configured to reinforce the rotation.

19. The energy machine according to claim 16, wherein two units of permanent magnets are configured to revolve on a single spindle and are positioned in 90 degrees angle from each other, wherein each unit comprises of three magnets, wherein one magnet is switchable from “N” pole to “S” pole and from “S” pole to “N” pole and serves as axis of rotation, wherein the other magnets in each unit are a pair of permanent magnets without switches, wherein one magnet of the pair of magnets is above the switchable magnet and the other magnet of the pair of magnets is under the switchable magnet, wherein the magnet above the switchable magnet is positioned with the “N” pole facing down and the magnet under the switchable magnet is positioned with the “N” pole facing up, wherein when the switchable magnet is switched so as to have the “N” pole facing up and the “S” pole facing down the combined magnetic forces of pull and push elevate the pair of magnets and creating propelling force in one unit that reinforces the propelling force of the other unit of magnets.
